(19) United States
(12) Patent Application Publication
(10) Pub. No.: US 2017/0295983 A1
(43) Pub. Date: Oct. 19, 2017

(54) METHOD AND SYSTEM FOR BEVERAGE BREWING MANAGEMENT

(71) Applicant: acaia Corporation, Cupertino, CA (US)

(72) Inventor: Rex Poway TSENG, Cupertino, CA (US)

(73) Assignee: acaia Corporation, Cupertino, CA (US)

(21) Appl. No.: 15/278,640

(22) Filed: Sep. 28, 2016

(30) Foreign Application Priority Data
Apr. 13, 2016 (TW) 105111562

(51) Int. Cl. A47J 31/00; A47J 31/52; A47J 31/42

(52) U.S. Cl. CPC A47J 31/002; A47J 31/42; A47J 31/52

(57) ABSTRACT

A method and a system are disclosed for managing a brewing process in which a solution is produced by mixing a solvent with a solute and a beverage is extracted from the solution. The system includes a temperature sensor device for sensing a temperature change per unit time of the solvent to create temperature information; a first measurement device for sensing a weight increase per unit time of the beverage to create first weight information while counting the time elapsed in the brewing process to create timing information; and a computing device comparing preset standard-state information with the temperature, first weight and timing information. A warning message is displayed on the computing device to remind a brewing operator to stop brewing the beverage when any of the temperature, first weight and timing information created at a specific unit time does not match the standard-state information of the same unit time.

### FIELD OF THE INVENTION

The present invention relates to a beverage brewing management method, and more particularly, to a beverage brewing management method that enables a brewing operator to ensure a consistent taste for the same type of beverage brewed at different times.

### BACKGROUND OF THE INVENTION

The world's cuisine culture is changing, diversified food ingredients are available, and a variety of ways for cooking food has been developed. To provide diversified liquid drinks in a convenient manner, many specific systems and methods for this purpose have also been developed.

Currently, specialty beverage stores are common in the market to prepare customized beverages for customers according to their preference in beverage temperature or sweetness, for example. However, in these beverage stores, the beverages are prepared manually, and the taste of the prepared beverages often changes with the beverage brewing operators' experience. Further, the taste of the same type of beverage prepared at different times, even by the same one brewing operator, might not be consistent.

In view that an inexperienced brewing operator might not be able to brew the same type of beverage with consistent taste, it is desirable to develop a method and a system, of which an examining mechanism can help any brewing operator brew beverages with consistent taste.

### SUMMARY OF THE INVENTION

A primary object of the present invention is to enable a brewing operator, either an experienced or an inexperienced one, to always ensure a consistent taste for the same type of beverage brewed at different times and accordingly, reduce loss of material caused by incorrect beverage brewing.

To achieve the above and other objects, the present invention provides a beverage brewing management system for managing a brewing process in which a solute and a solvent are mixed together to produce a solution and a beverage is extracted from the solution. According to a preferred embodiment thereof, the management system includes a computing device, a temperature sensor device, a first measurement device, a grinder device, a second measurement device and a connection device.

The computing device is connected to the connection device and includes a warning unit, a comparison unit and a storage unit. The warning unit and the storage unit are electrically connected to the comparison unit. The warning unit is used to display a warning message and the storage unit is used to store a group of standard-state information per unit time for the brewing process.

The temperature sensor device is connected to the computing device via the connection device to sense a temperature change per unit time of the solvent and create and transmit corresponding temperature information to the comparison unit. The first measurement device is also connected to the computing device via the connection device, and includes a first weighing unit and a timer unit. The first weighing unit senses a weight increase per unit time of the beverage and accordingly creates a piece of first weight information, which is transmitted to the comparison unit. The timer unit counts a total time of the brewing process and creates corresponding timing information, which is transmitted to the comparison unit.

The grinder device is connected to the computing device via the connection device, and includes a grinding unit to grind a solid material into the solute during a grinding process; and the grinding unit can selectively start or stop grinding the solid material under control. The second measurement device is connected to the computing device via the connection device, and includes a second weighing unit for sensing a weight increase per unit time of the solute and creating corresponding second weight information, which is transmitted to the comparison unit.

The connection device includes a plurality of connection units that are connected to one another. The connection units are connected to the temperature sensor device, the first measurement device, the grinder device and the second measurement device in a one-to-one correspondence, so that the connection device can transfer the temperature information, the first weight information, the timing information and the second weight information to one of the temperature sensor device, the first measurement device, the grinder device and the second measurement device.

The comparison unit compares the temperature information, the first weight information, the timing information and the second weight information with the standard-state information of the same unit time. When any one of the temperature information, the first weight information, the timing information and the second weight information created at a specific unit time does not match the standard-state information of the same unit time, the comparison unit generates a warning signal to the warning unit for the same to display a warning message.

According to another preferred embodiment thereof, the management system includes a computing device, a first measurement device, a grinder device, a second measurement device and a brewing device. While the computing device, the first measurement device, the grinder device and the second measurement device for the management system in the second preferred embodiment are structurally identical to those in the first preferred embodiment, the brewing device for the second preferred includes a temperature sensor device, a control unit and a liquid sensor device.

The temperature sensor device in the second preferred embodiment also senses a temperature change per unit time of the solvent to create corresponding temperature information, which is transmitted to the comparison unit. The control unit provides control to selectively add or stop adding the solvent to the solute. The liquid sensor device is capable of sensing a weight increase per unit time of the solvent to create corresponding flow information, which is transmitted to the comparison unit.

The comparison unit compares the temperature information, the first weight information, the timing information, the second weight information and the flow information with the standard-state information of the same unit time. When any one of the temperature information, the first weight information, the timing information, the second weight information and the flow information created at a specific unit time does not match the standard-state information of the same unit time, the comparison unit generates a warning signal to the warning unit for the same to display a warning message. Meanwhile, the comparison unit also generates a stop signal to the control unit for the latter to stop the solvent from being added to the solute.

To achieve the above and other objects, the present invention also provides a beverage brewing management method. According to a preferred embodiment thereof, the management method includes a standard brewing step, in which a solvent is poured into a solute to brew a standard beverage; a measuring step being performed synchronously with the standard brewing step to measure and record standard physical changes per unit time of the standard beverage to create corresponding physical information; a standardizing step, in which one of multiple groups of the physical information, which are created by repeating the standard brewing step and the measuring step several times, is selected to be standard-state information; a brewing step, in which the solvent is poured into the solute to brew a beverage; a comparing step, in which comparison-state information, which is created during the brewing step by measuring physical changes per unit time of the beverage, is compared with the standard-state information of the same unit time to determine whether the comparison-state information is approximate to the standard-state information; and a reminding step, in which a warning message is generated to remind the brewing operator when a difference between the comparison-state information and the standard-state information of the same unit time exceeds a preset error value.

According to another embodiment thereof, the beverage brewing management method further includes a computing step between the measuring step and the standardizing step to perform a computation on the physical information to create state information of the standard beverage.

In the preferred embodiment of the beverage brewing management method, the physical changes of the beverage can be a weight increase per unit time of the beverage, a temperature change of the beverage or a total time elapsed in the brewing step; and the physical changes of the standard beverage can be a weight increase per unit time of the standard beverage, a temperature change of the beverage or a total time elapsed in the standard brewing step.

Further, in the measuring step, a weight increase per unit time of the standard beverage is measured and a graphic data representing the physical information is created based on the measured weight increase per unit time.

The present invention is characterized in that the comparison unit compares the temperature information, the first weight information and the timing information with the standard-state information of the same unit time, and the computing device will display a warning message when any of the temperature information, the first weight information and the timing information created at a specific unit time does not match the standard-state information of the same unit time. The displayed warning message reminds the brewing operator to immediately stop the brewing process and can therefore reduce loss of material caused by incorrect beverage brewing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a modular block diagram of a beverage brewing management system according to a first preferred embodiment of the present invention;

FIG. 2 is a perspective view showing the management system according to the first preferred embodiment of the present invention is used with a brewing device;

FIG. 3 is a flowchart showing the steps included in a beverage brewing management method according to the first preferred embodiment of the present invention;

FIG. 4 is a pictorial description of the Setting step (S1) shown in FIG. 3;

FIG. 5 is a pictorial description of the Standard Resetting step (S2) shown in FIG. 3;

FIG. 6 is a pictorial description of the Standard Brewing step (S3) shown in FIG. 3;

FIG. 7 is a pictorial description of the Measuring step (S4) shown in FIG. 3;

FIG. 8 is a pictorial description of the Standardizing step (S5) shown in FIG. 3;

FIG. 9 is a pictorial description of the Resetting step (S6) shown in FIG. 3;

FIG. 10 is a pictorial description of the Brewing step (S7) shown in FIG. 3;

FIG. 11 is a pictorial description of the Comparing step (S8) shown in FIG. 3;

FIG. 12 is a pictorial description of the Reminding step (S9) shown in FIG. 3;

FIG. 13 is a flowchart showing the steps included in a beverage brewing management method according to a second preferred embodiment of the present invention;

FIG. 14 is a modular block diagram of a beverage brewing management system according to a third preferred embodiment of the present invention; and

FIG. 15 is a modular block diagram of a connection device included in a beverage brewing management system according to a fourth preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

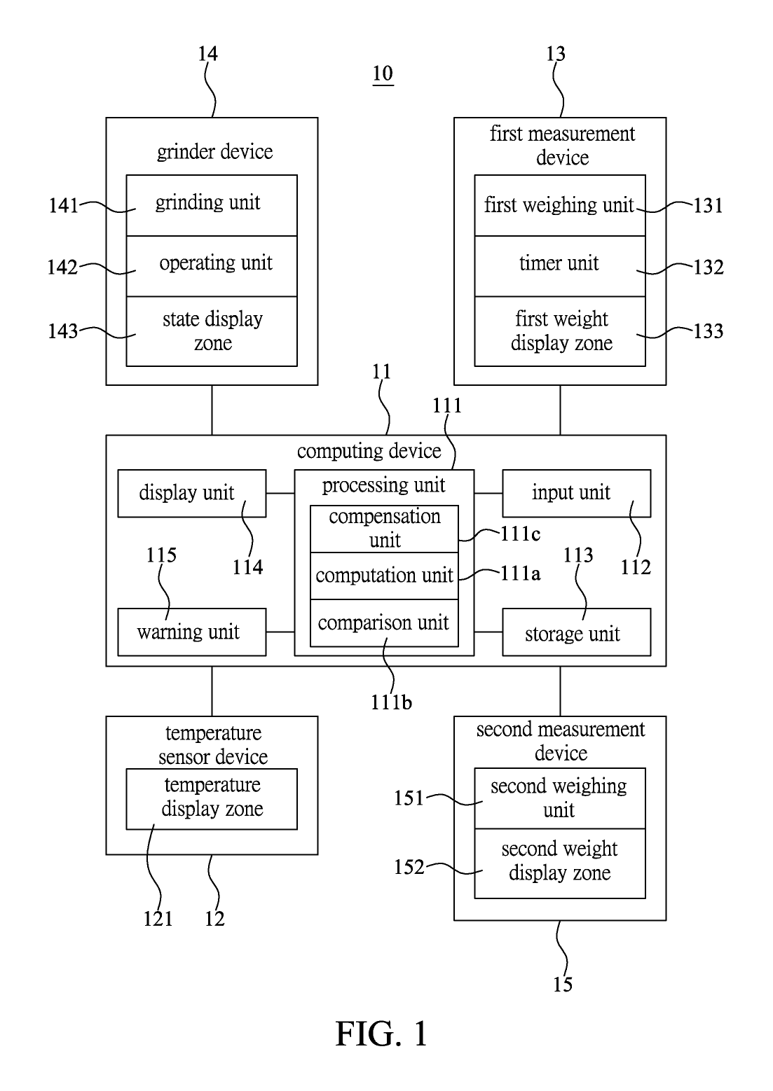

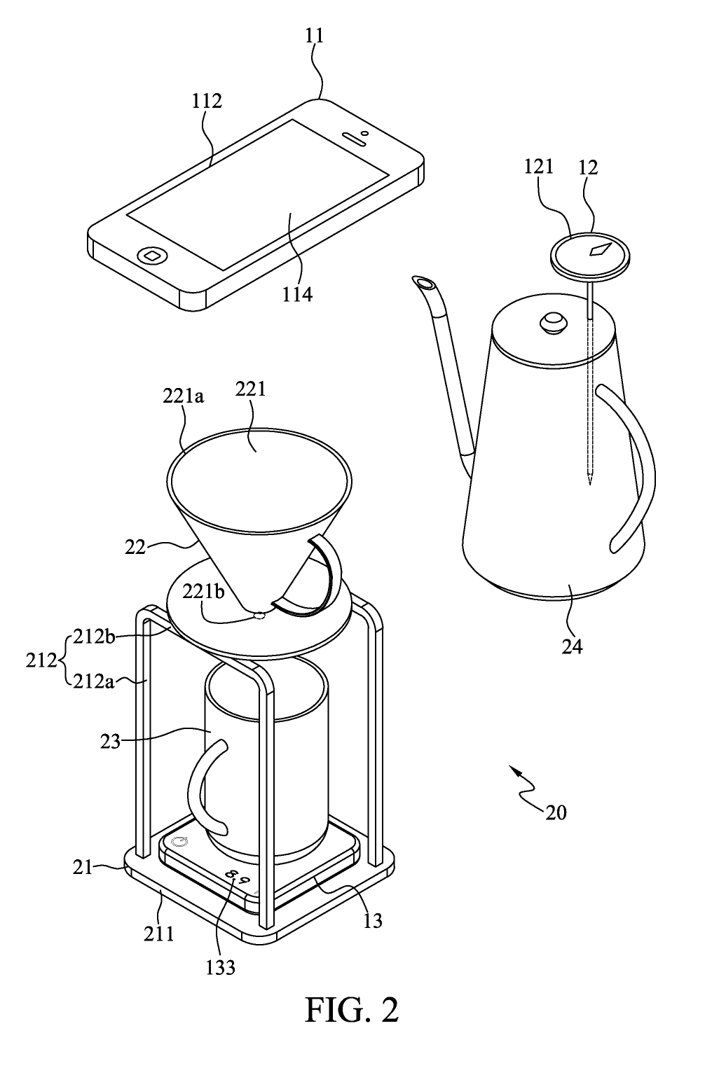

Please refer to FIG. 1 that is a modular block diagram of a beverage brewing management system 10 according to a first preferred embodiment of the present invention, and to FIG. 2 that shows a brewing device 20 for use with the beverage brewing management system 10 of FIG. 1. As shown, the brewing device 20 includes a support frame 21, a filter unit 22, a container 23, and a pour-over kettle 24. The support frame 21 includes a base portion 211 and two spaced leg portions 212. Each of the leg portions 212 includes two sideward spaced connection legs 212a, which are connected at respective lower end to the base portion 211, and a support section 212b connected to between upper ends of the two connection legs 212a and accordingly located at a height above the base portion 211. For the purpose of conciseness and clarity, the beverage brewing management system 10 is also briefly referred to as the management system 10 herein.

The filter unit 22 is assembled to the support sections 212b of the support frame 21, and defines a downward tapered receiving space 221. The receiving space 221 has an inlet opening 221a and an outlet opening 221b, which has dimensions smaller than that of the inlet opening 221a. The outlet opening 221b defines an outgoing direction toward the base portion 211 of the support frame 21.

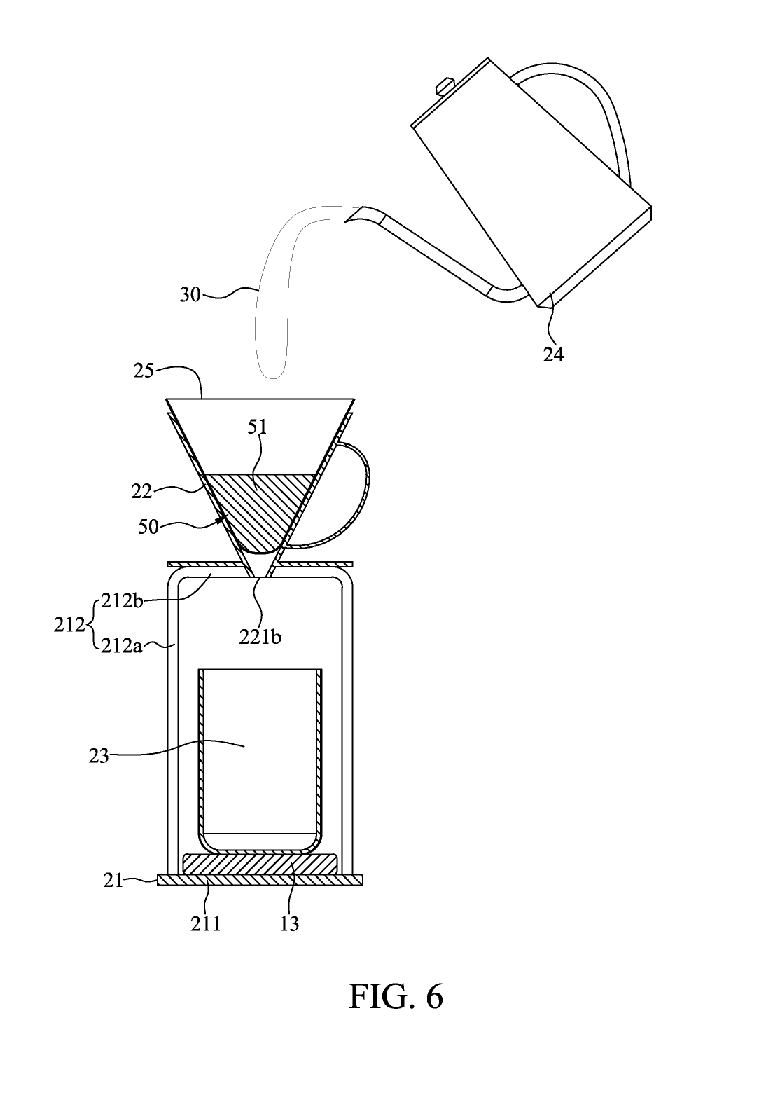

The container 23 is disposed between the base portion 211 and the support sections 212b of the support frame 21. The pour-over kettle 24 holds an amount of liquid solvent 30 therein, and the solvent 30 can be poured from the pour-over kettle 24 into the receiving space 221 via the inlet opening 221a (see FIG. 6). Thereafter, the solvent 30 can flow through the outlet opening 221b into the container 23.

In the illustrated first preferred embodiment, the management system 10 includes a computing device 11, a temperature sensor device 12, a first measurement device 13, a grinder device 14, and a second measurement device 15.

The computing device 11 can be a commonly seen mobile device, such as a smartphone, a tablet computer, or a notebook computer; and includes a processing unit 111 for computing information, an input unit 112 at where information can be input to the computing device 11, a storage unit 113 for storing information, a display unit 114 for displaying information, and a warning unit 115 for displaying a warning message. The input unit 112, the storage unit 113, the display unit 114 and the warning unit 115 all are electrically connected to the processing unit 111. More specifically, the processing unit 111 includes a computation unit 111a for performing a computation on information, a comparison unit 111b for comparing at least two pieces of information with one another, and a compensation unit 111c for providing an information compensation amount. In the illustrated first preferred embodiment, the input unit 112 and the display unit 114 together constitute a touch screen.

The temperature sensor device 12 is connected to the computing device 11 and is used to sense changes in temperature increase per unit time of the solvent 30. The temperature sensor device 12 is provided with a temperature display zone 121, in which the sensed change of temperature increase is shown. The first measurement device 13 is disposed between the base portion 211 of the support frame 21 and the container 23, and is connected to the computing device 11. The first measurement device 13 has a first weighing unit 131, a timer unit 132, and a first weight display zone 133. The first weighing unit 131 measures a container-alone weight increase of the container 23; the timer unit 132 counts the time elapsed during the course the container-alone weight increase of the container 23 is measured. Finally, the first weight display zone 133 displays the container-alone weight increase of the container 23.

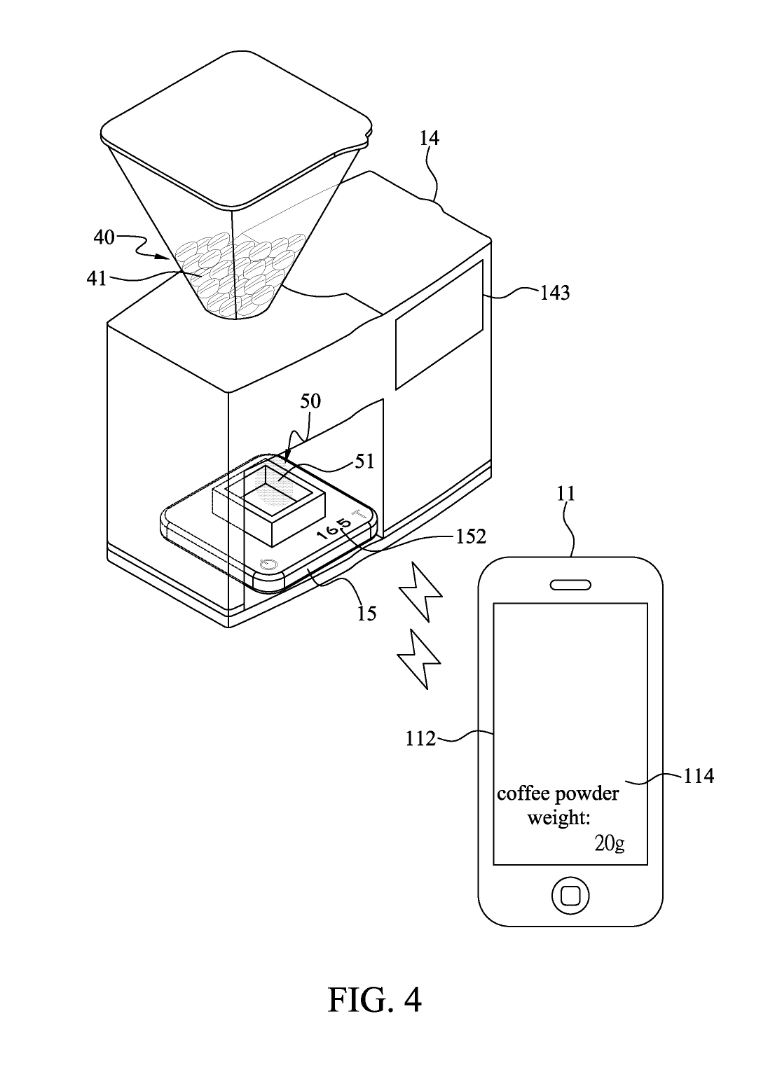

The grinder device 14 is connected to the computing device 11 and has a grinding unit 141, a operating unit 142 and a state display zone 143. The operating unit 142 drives the grinding unit 141 to grind a solid material 40 into a solute 50 (see FIG. 4), and generates corresponding rotating information to the state display zone 143, so that state display zone 143 can display an operating state of the grinder device 14.

The second measurement device 15 has a second weighing unit 151 and a second weight display zone 152. The second weighing unit 151 measures a weight increase per unit time of the solute 50, and the second weight display zone 152 displays the measured weight increase of the solute 50. In the illustrated first preferred embodiment, the temperature sensor device 12, the first measurement device 13, the grinder device 14, and the second measurement device 15 are wirelessly connected to the computing device 11.

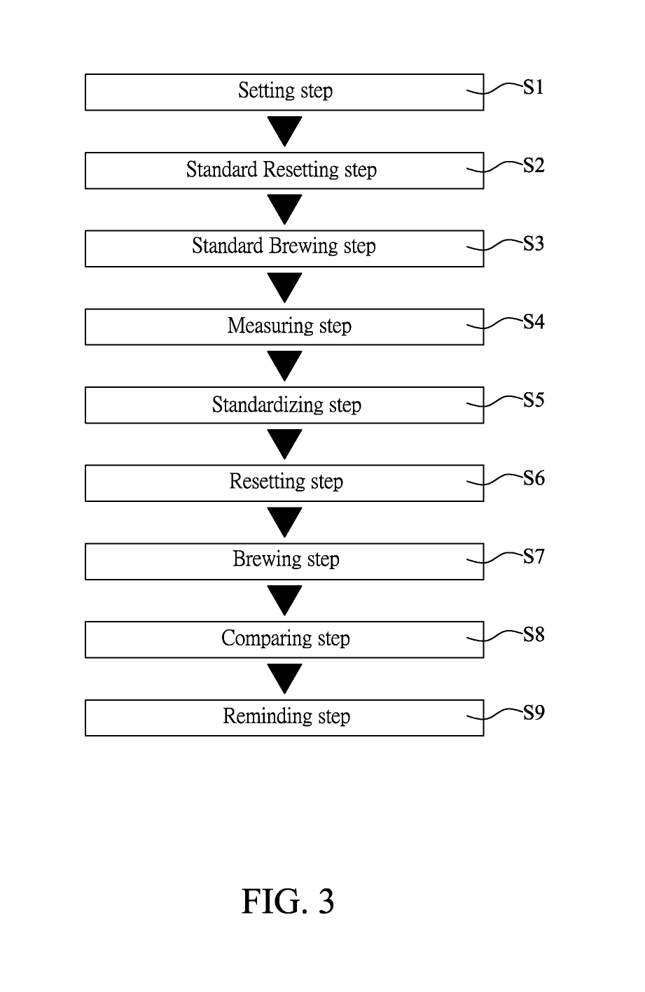

FIG. 3 is a flowchart showing the steps included in a beverage brewing management method according to the first preferred embodiment of the present invention; and FIG. 4 is a pictorial description of a Setting step (S1) shown in FIG. 3. Please refer to FIGS. 2, 3 and 4. In practical use of the management system 10 in the first preferred embodiment, first put an amount of the solid material 40 in the grinder device 14. In the illustrated first preferred embodiment, the solid material 40 includes a plurality of coffee beans 41. Then, perform the Setting step (S1) by using the input unit 112 on the computing device 11 to input information of a standard state. Herein, the information of the standard state is also briefly referred to as the standard-state information. The input standard-state information is transmitted to the processing unit 111 of the computing device 11 and the processing unit 111 further transfers the standard-state information to the storage unit 113 while generates a start signal to the operating unit 142 of the grinder device 14. The storage unit 113 stores the standard-state information on receipt of it. On receiving the start signal, the operating unit 142 drives the grinding unit 141 of the grinder device 14 to grind the coffee beans 41 into coffee powder 51, i.e. the above-mentioned solute 50. As soon as the coffee powder 51 falls on a surface of the second measurement device 15, the second weighing unit 151 of the second measurement device 15 starts measuring the weight per unit time of the coffee powder 51 and creates corresponding second weight information, which is simultaneously transmitted to the comparison unit 111b and the second weight display zone 152. The second weight display zone 152 immediately displays the second weight information on receipt of it.

On receiving the second weight information, the comparison unit 111b compares the second weight information with the standard-state information to determine whether the second weight information matches the standard-state information. If the comparison unit 111b determines the second weight information is different from the standard-state information, the operating unit 142 of the grinder device 14 will keep rotating and driving the grinding unit 141 to grind the coffee beans 41 into coffee powder 51. The coffee powder 51 falls on the second measurement device 15 continuously, bringing the second weighing unit 151 of the second measurement device 15 to measure the weight per unit time of the coffee powder 51 and transmit the corresponding second weight information to the comparison unit 111b, which compares the second weight information obtained at each specific unit time with the standard-state information of the same unit time. As soon as the comparison unit 111b determines the second weight information matches the standard-state information, the processing unit 111 of the computing device 11 generates a stop signal to the operating unit 142, so that the grinding unit 141 of the grinder device 14 stops grinding the coffee beans 41.

For example, a brewing operator can input at the input unit 112 to set that total 20 g of coffee powder 51 is needed. At this point, the operating unit 142 of the grinder device 14 drives the grinding unit 141 to grind the coffee beans 41 into coffee powder 51. When the amount of 20 g of coffee powder 51 is measured by the second weighing unit 151 of the second measurement device 15, the processing unit 111 of the computing device 11 will order the operating unit 142 of the grinder device 14 to stop rotating. It is noted a trace amount of coffee powder 51 will still fall on the second measurement device 15 after the grander device 14 has stopped operating, and the final amount of coffee powder 51 measured by the second measurement device 15 is, for example, 22 g. At this point, the compensation unit 111c of the computing device 11 will generate a weight compensation of −2 g to the second weighing unit 151 of the second measurement device 15. With this arrangement, when the operating unit 142 of the grinder device 14 drives the grinding unit 141 to grind the coffee beans 41 the next time, the processing unit 111 will order the operating unit 142 of the grinder device 14 to stop operating as soon as an amount of 18 g of coffee powder 51 is measured by the second weighing unit 151 of the second measurement device 15.

Thereafter, a sheet of filter paper 25 capable of separating the solid material 40 from a liquid is placed in the receiving space 221, such that the filter paper 25 forms a funnel corresponding to the shape of the receiving space 221. At this point, a part of the filter paper 25 covers the outlet opening 221b of the receiving space 221. Then, an amount of the solute 50 is positioned on the filter paper 25. In the illustrated first preferred embodiment, the solute 50 is coffee powder 51. However, it is understood the use of coffee powder 51 as the solute 50 is only illustrative and not intended to limit the present invention in any way. That is, in other embodiments, the solute 50 can be, for example, green tea powder, red tea powder or other powdery brewing substances.

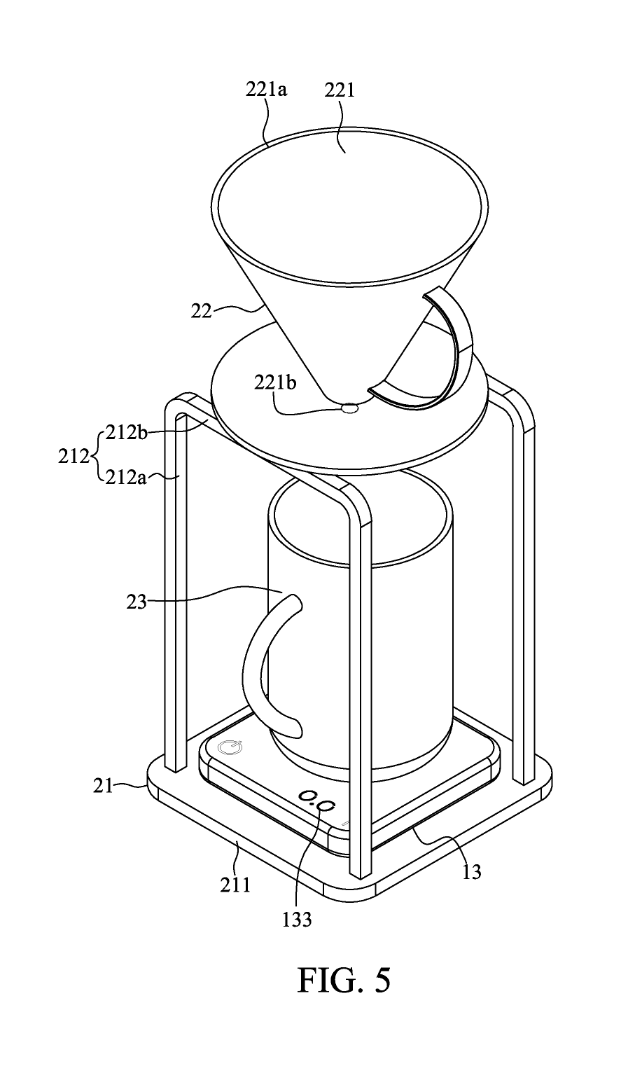

Please refer to FIGS. 2, 3 and 5, wherein FIG. 5 is a pictorial description of a Standard Resetting step (S2) shown in FIG. 3. After the filter paper 25 and the solute 50 have been positioned in the receiving space 221, the first measurement device 13 is turned on for the first weighing unit 131 thereof to measure the weight of the container 23 and display the measured weight value in the first weight display zone 133 on the first measurement device 13. To avoid possible errors, the Standard Resetting step (S2) is performed to reset the first measurement device 13 so that the weight value shown in the first weight display zone 133 is reset to zero.

Please refer to FIGS. 2, 3 and 6, wherein FIG. 6 is a pictorial description of a Standard Brewing step (S3) shown in FIG. 3. The Standard Brewing step (S3) starts when the Standard Resetting step (S2) has been completed. First, use the pour-over kettle 24 to pour an amount of the solvent 30 into the receiving space 221 of the filter unit 22 and allow the solute 50 and the solvent 30 to mix together to produce an amount of solution 60. The solution 60 is subjected to an extraction process with the help of the filter unit 22 and the filter paper 25 to produce an amount of standard beverage 70. The produced standard beverage 70 flows through the outlet opening 221b of the receiving space 221 into the container 23. In the illustrated first preferred embodiment, the solvent 30 is hot water. However, it is understood the use of hot water as the solvent 30 is only illustrative and not intended to limit the present invention in any way. That is, in other embodiments, the solvent 30 can be any liquid suitable for dissolving the solute 50.

In the illustrated first preferred embodiment of the present invention, the solvent 30 can be continuously or intermittently poured from the pour-over kettle 24 into the solute 50 without any particular limit to the way of adding the solvent 30 to the receiving space 221. The manner of adding the solvent 30 can be adjusted according to an operator's preference.

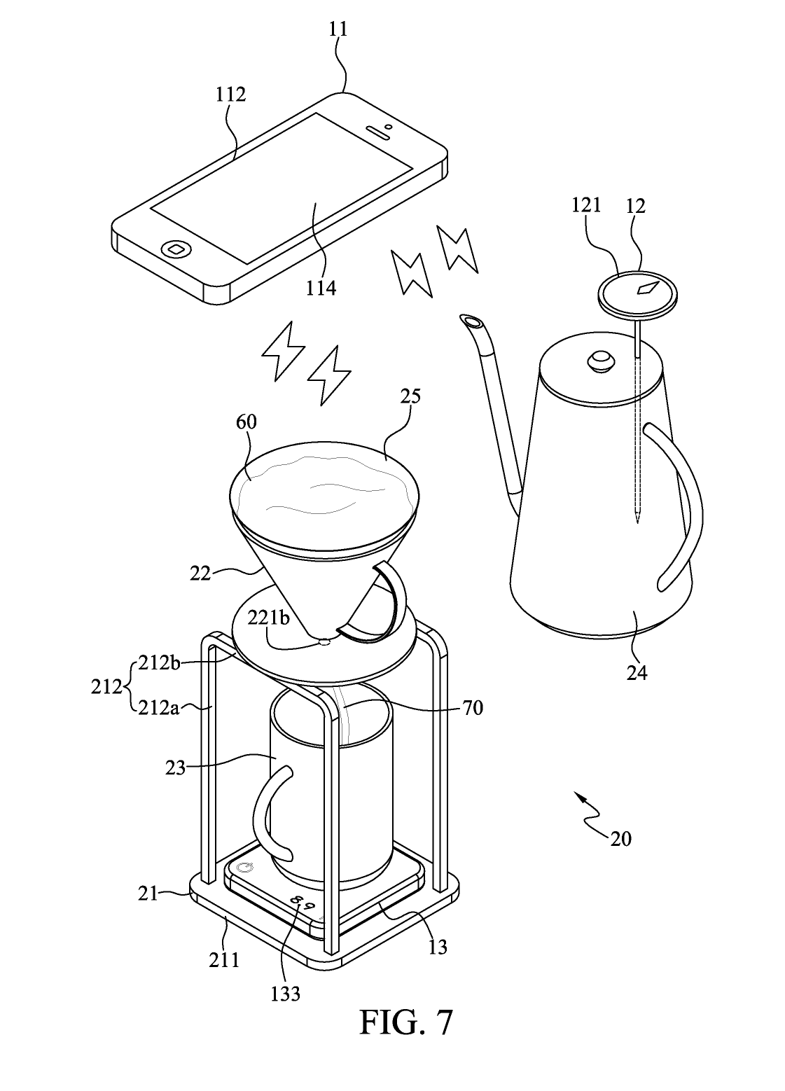

Please refer to FIGS. 2, 3 and 7, wherein FIG. 7 is a pictorial description of a Measuring step (S4) shown in FIG. 3. The Measuring step (S4) is performed synchronously with the Standard Brewing step (S3). Before the solvent 30 is poured from the pour-over kettle 24 into the receiving space 221 of the filter unit 22, the temperature sensor device 12 senses a change in temperature increase per unit time of the solvent 30 and transmits corresponding temperature information to the temperature display zone 121, in which a temperature value per unit time corresponding to the temperature information is shown.

As soon as the solvent 30 is poured from the pour-over kettle 24 into the receiving space 221 of the filter unit 22, the first weighing unit 131 also senses a weight increase per unit time of the standard beverage 70 to create corresponding first weight information while the timer unit 132 counts a brew processing time, by which the standard beverage 70 is extracted from the solution 60, to create corresponding timing information. The temperature information, the first weight information and the timing information together constitute a group of corresponding physical information that is stored in the storage unit 113 and can be represented in the form of a graphic data.

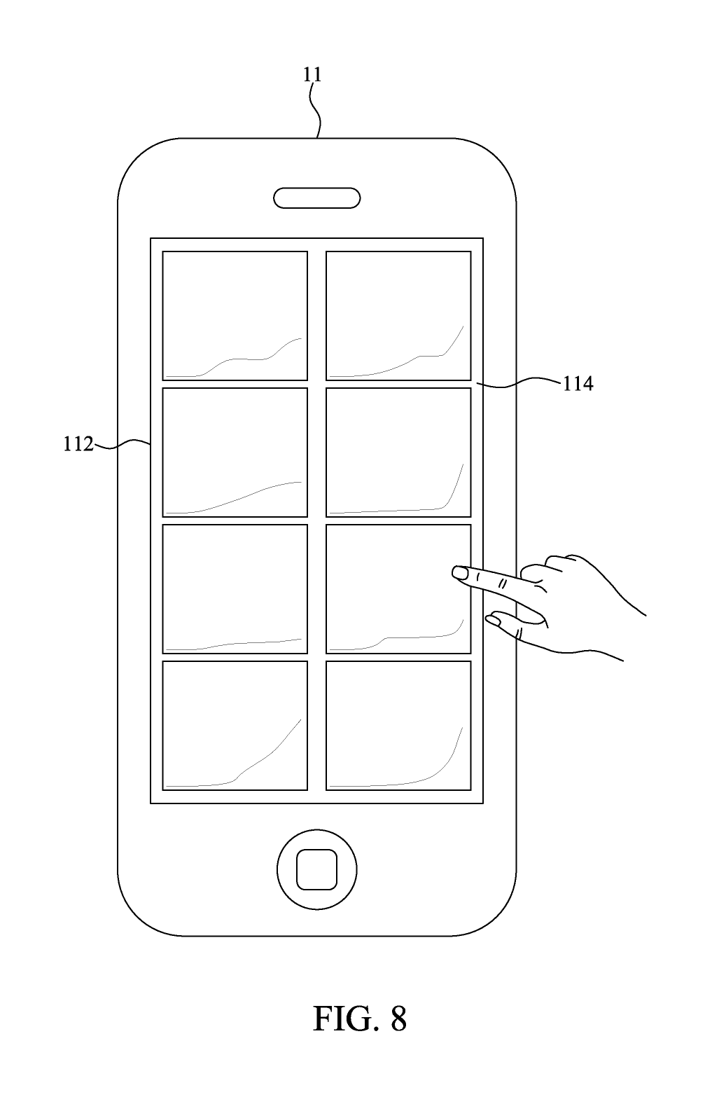

Referring to FIGS. 2, 3 and 8, wherein FIG. 8 is a pictorial description of a Standardizing step (S5) shown in FIG. 3. When the Standard brewing step (S3) and the Measuring step (S4) have been performed repeatedly, multiple groups of physical information are created. Thereafter, the Standardizing step (S5) is performed. In the step S5, the brewing operator inputs at the input unit 112 of the computing device 11 to select one of the multiple groups of physical information to be the standard-state information. In the illustrated first preferred embodiment, the Standard brewing step (S3) and the Measuring step (S4) must be repeatedly performed several times to obtain the standard-state information. However, in another preferred embodiment of the present invention, the physical information can be created by inputting the first weight information, the timing information and the temperature information at the input unit 112 of the computing device 11 to create the physical information, which is stored in the storage unit 113 to constitute the standard-state information.

When the storage unit 113 of the computing device 11 receives any further temperature information, first weight information or timing information after the standard-state information has been stored in the storage unit 113, the comparison unit 111b of the processing unit 111 will compare the current temperature information, first weight information and timing information with the standard-state information and determine whether the temperature information, first weight information and timing information are approximate to the standard-state information.

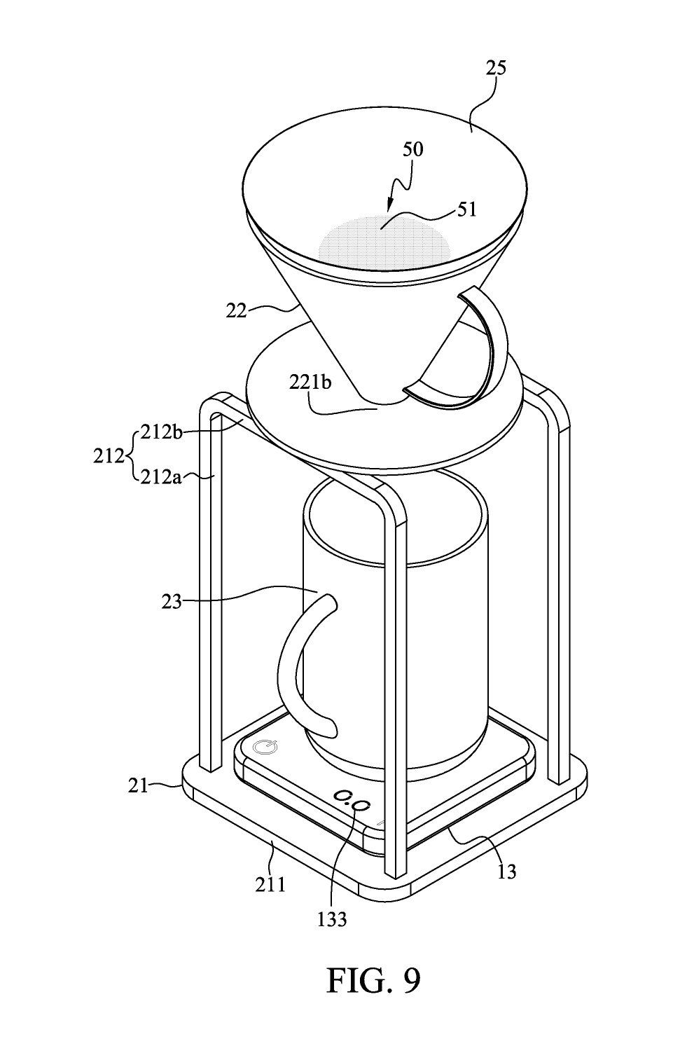

FIG. 9 is a pictorial description of a Resetting step (S6) shown in FIG. 3. Please refer to FIGS. 2, 3 and 9. In the Resetting step (S6), first sequentially place the filter paper 25 and the coffee powder 51 in the receiving space 221 of the filter unit 22. Then, turn on the first weighing unit 131 of the first measuring device 13 to measure the weight of the container 23 and the measured weight value is displayed in the first weight display zone 133. Thereafter, reset the first weighing unit 131, so that the value shown in the first weight display zone 133 is zero.

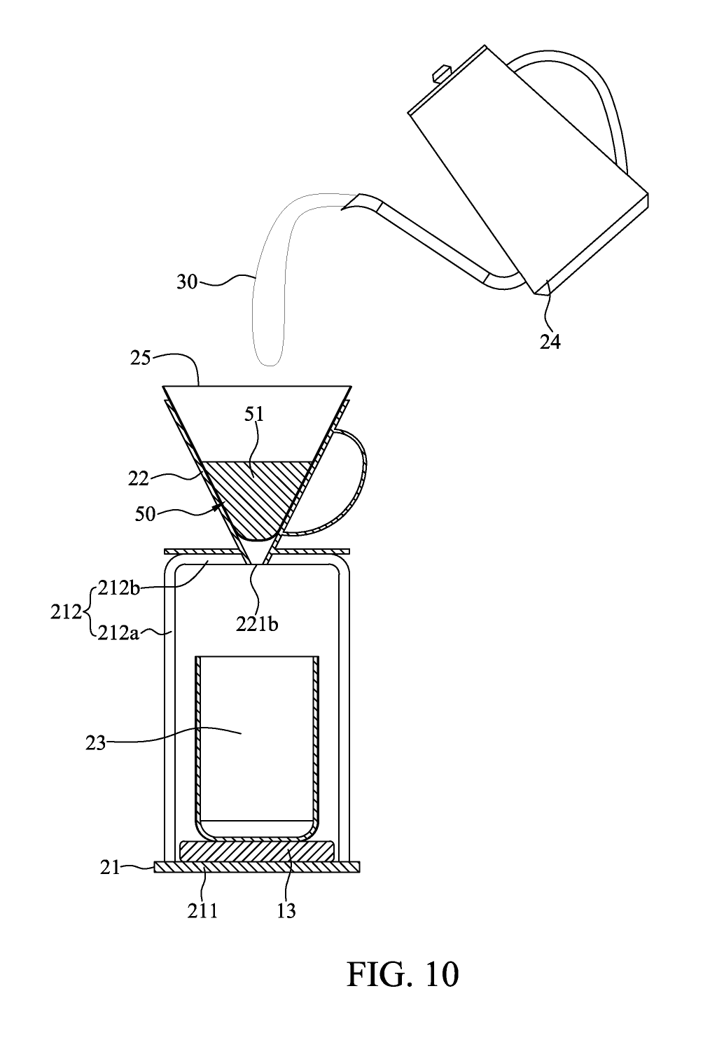

FIG. 10 is a pictorial description of a Brewing step (S7) shown in FIG. 3. Please refer to FIGS. 2, 3 and 10. The Brewing step (S7) starts when the Resetting step (S6) is completed. First, use the pour-over kettle 24 to pour an amount of the solvent 30 into the receiving space 221 of the filter unit 22 and allow the solvent 30 and the coffee powder 51 to mix together to produce an amount of the solution 60. The solution 60 is subjected to an extraction process with the help of the filter unit 22 and the filter paper 25 to produce an amount of beverage 80. The produced beverage 80 flows through the outlet opening 221b of the receiving space 221 into the container 23.

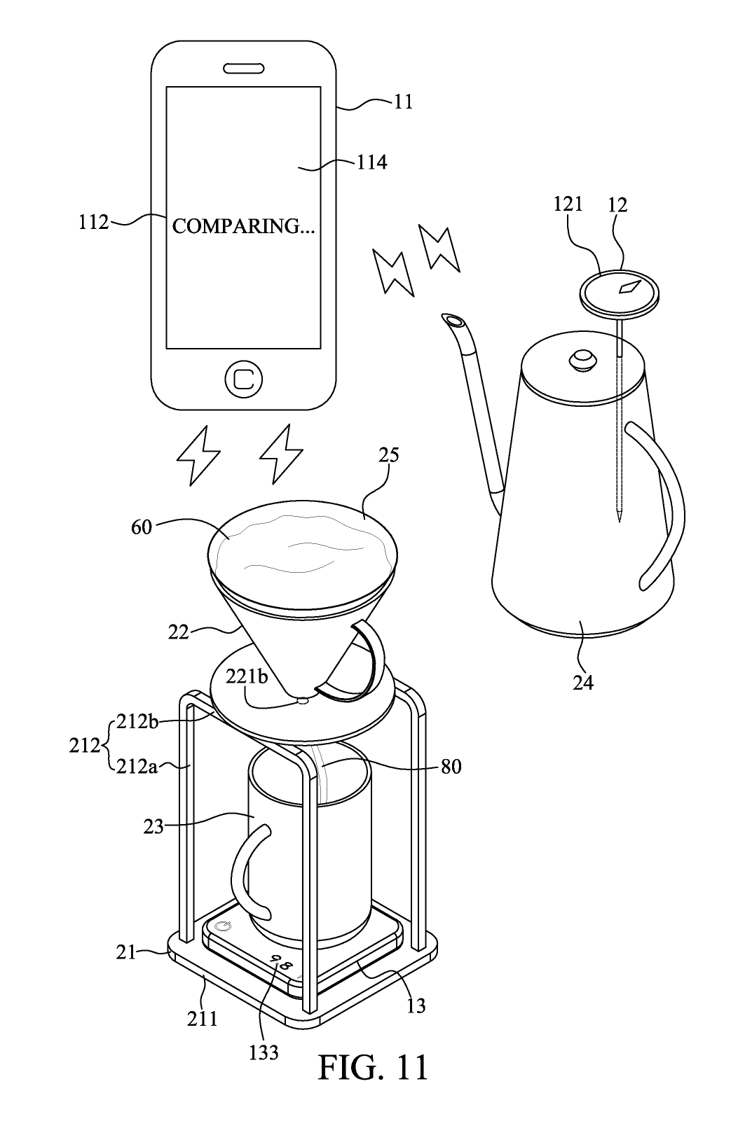

FIG. 11 is a pictorial description of a Comparing step (S8) shown in FIG. 3. Please refer to FIGS. 2, 3 and 11. The Comparing step (S8) is performed synchronously with the Brewing step (S7). Before the solvent 30 is poured from the pour-over kettle 24 into the receiving space 221 of the filter unit 22, the temperature sensor device 12 senses a change in temperature increase per unit time of the solvent 30 and transmits corresponding temperature information to the temperature display zone 121, in which a temperature value per unit time corresponding to the temperature information is shown.

As soon as the solvent 30 is poured from the pour-over kettle 24 into the receiving space 221 of the filter unit 22, the first weighing unit 131 also senses a weight increase per unit time of the beverage 80 to create corresponding first weight information while the timer unit 132 counts a brew processing time, by which the beverage 80 is extracted from the solution 60, to create corresponding timing information. The temperature information, the first weight information and the timing information together constitute a group of comparison-state information that is transmitted to the comparison unit 111b.

When the comparison unit 111b receives the comparison-state information, it compares the comparison-state information with the standard-state information of the same unit time. In the event the comparison-state information created at a specific unit time does not match the standard-state information of the same unit time or a difference between the comparison-state information and the standard-state information of the same unit time is greater than a preset error value, the comparison unit 111b will generate a warning signal to the warning unit 115.

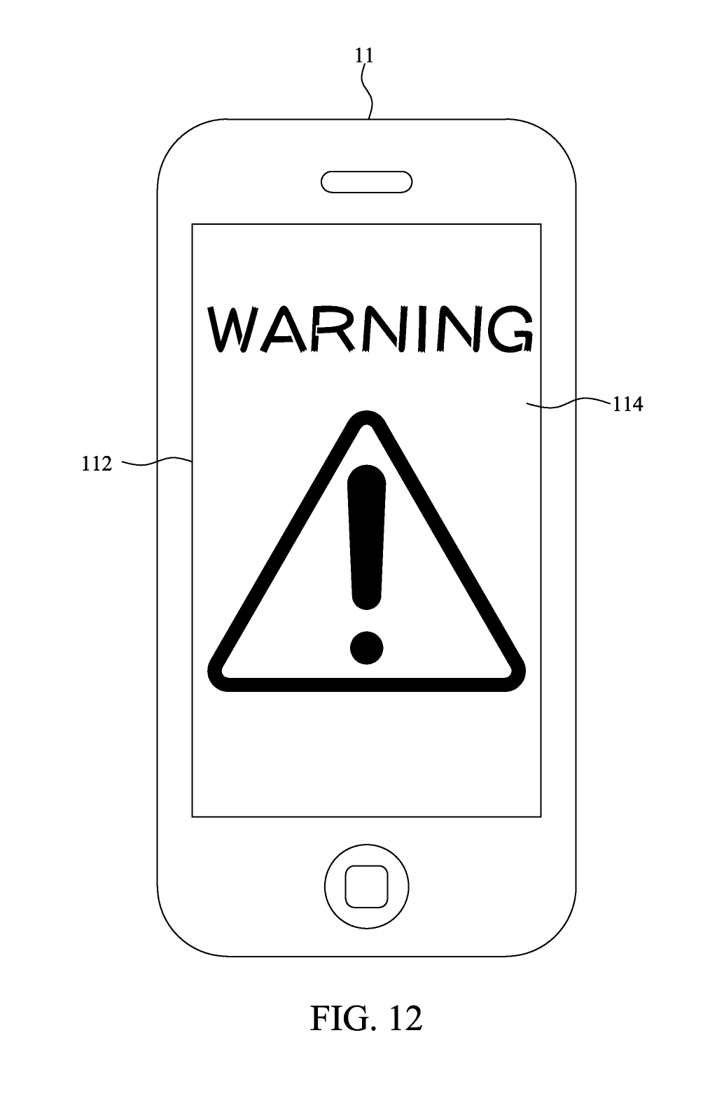

Please refer to FIGS. 2, 3 and 12, wherein FIG. 12 is a pictorial description of a Reminding step (S9) shown in FIG. 3. When the warning unit 115 receives the warning signal, it performs the Reminding step (S9). In the illustrated first preferred embodiment of the present invention, when the warning unit 115 receives the warning signal, it causes the display unit 114 to display a warning message for reminding the brewing operator. It is understood the display of the warning message at the display unit 114 is only illustrative and not intended to limit the present invention in any way. That is, in other embodiments, the warning unit 115 receiving the warning signal can, for example, cause the computing device 11 to vibrate for reminding the brewing operator.

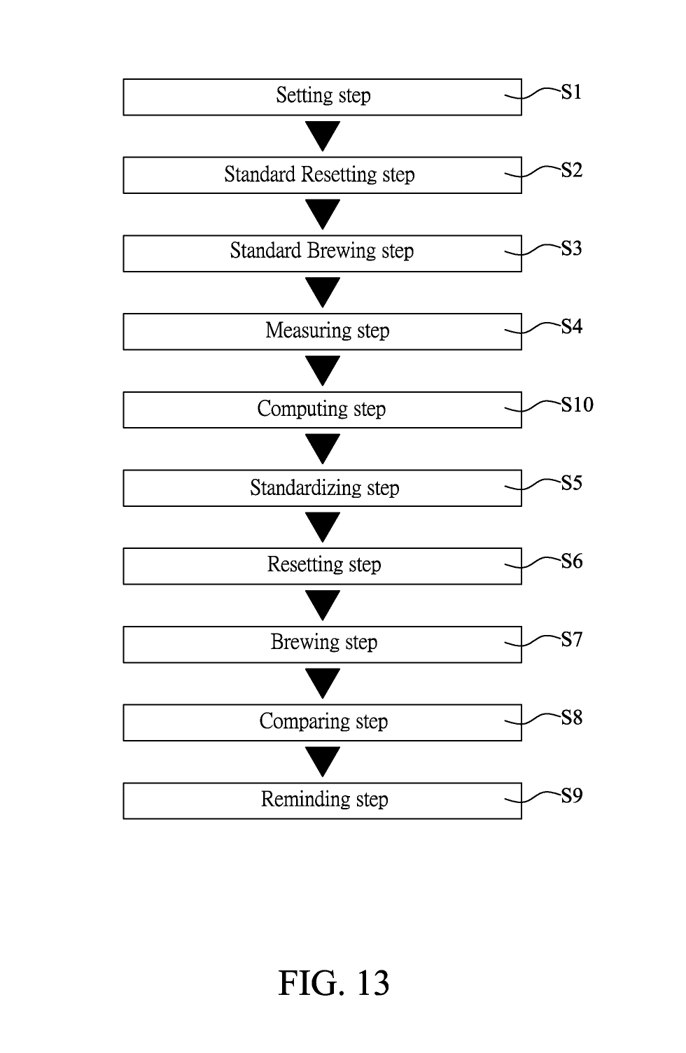

FIG. 13 is a flowchart showing the steps included in a beverage brewing management method according to a second preferred embodiment of the present invention. As shown, the beverage brewing management method in the second preferred embodiment is different from the first one in further having a Computing step (S10) between the Measuring step (S4) and the Standardizing step (S5). In the Computing step (S10), the computation unit 111a of the processing unit 111 performs a computation on the first weight information, the temperature information and the timing information to derive an average beverage output and an average extraction time. In this case, the first weight information, the temperature information, the timing information, the average beverage output and the average extraction time together constitute a group of physical information. In the Comparing step (S8), with the physical information constituted of the first weight information, the temperature information, the timing information, the average beverage output and the average extraction time, the comparison unit 111b can more accurately determine whether the comparison-state information is approximate to the standard-state information.

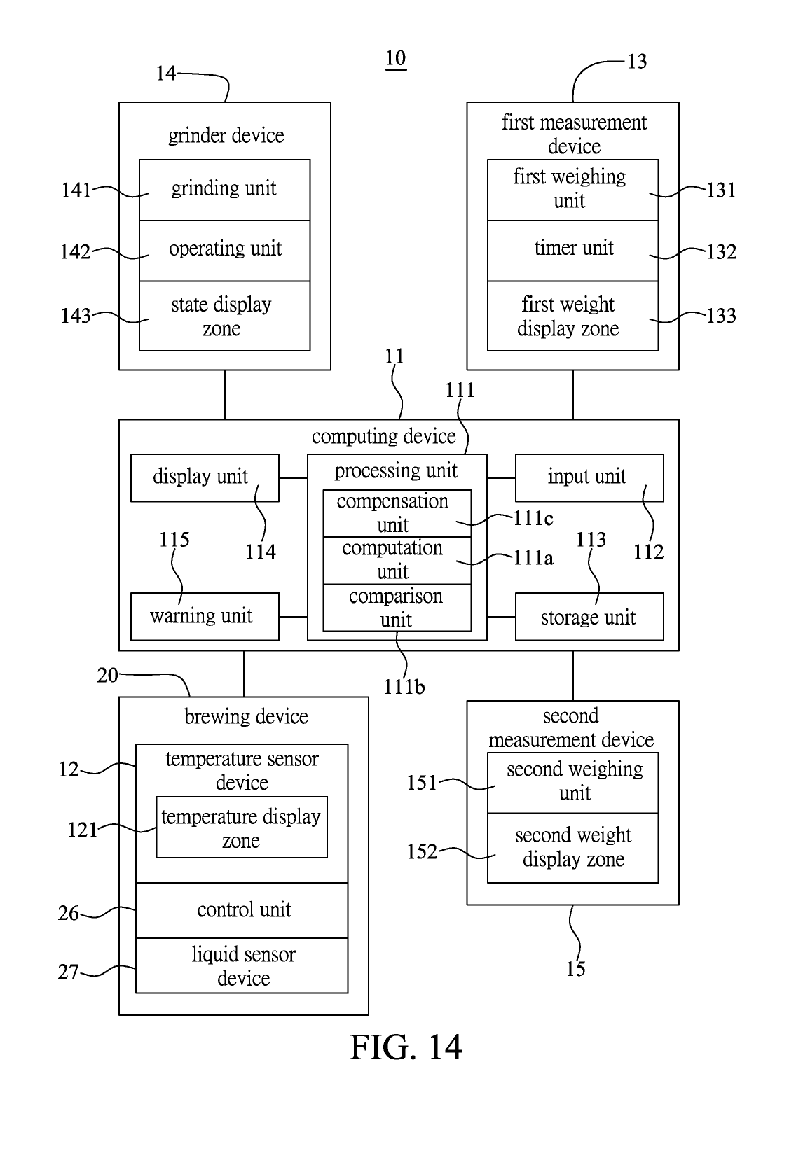

FIG. 14 is a modular block diagram of a management system 10 according to a third preferred embodiment of the present invention. The management system 10 in the third preferred embodiment is different from the first one in the brewing device 20 thereof. In the third preferred embodiment, the brewing device 20 is wirelessly connected to the computing device 11 and includes the temperature sensor device 12, a control unit 26, and a liquid sensor device 27. The control unit 26 provides control to selectively add or stop adding the solvent 30 to the solute 50. The liquid sensor device 27 is capable of sensing a weight increase per unit time of the solvent 30 to create corresponding flow information.

In practical use of the management system 10 in the third preferred embodiment, the first weight information, the temperature information, the timing information and the flow information together constitute a group of physical information after the Measuring step (S4) has been performed. Thereafter, the Standardizing step (S5) is performed to select the standard-state information from one of multiple groups of physical information. In the Comparing step (S8) later, the first weight information, the temperature information, the timing information and the flow information together constitute the comparison-state information. The comparison unit 111b compares the comparison-state information with the standard-state information of the same unit time. In the event the comparison-state information created at a specific unit time does not match the standard-state information of the same unit time or a difference between the comparison-state information and the standard-state information of the same unit time is greater than a preset error value, the comparison unit 111b will generate a warning signal and a stop signal at the same time.

The warning signal is transmitted to the warning unit 115, so that a warning message is shown in the display unit 114. The stop signal is transmitted to the control unit 26 of the brewing device 20, so that the control unit 26 stops the adding of the solvent 30 to the solute 50.

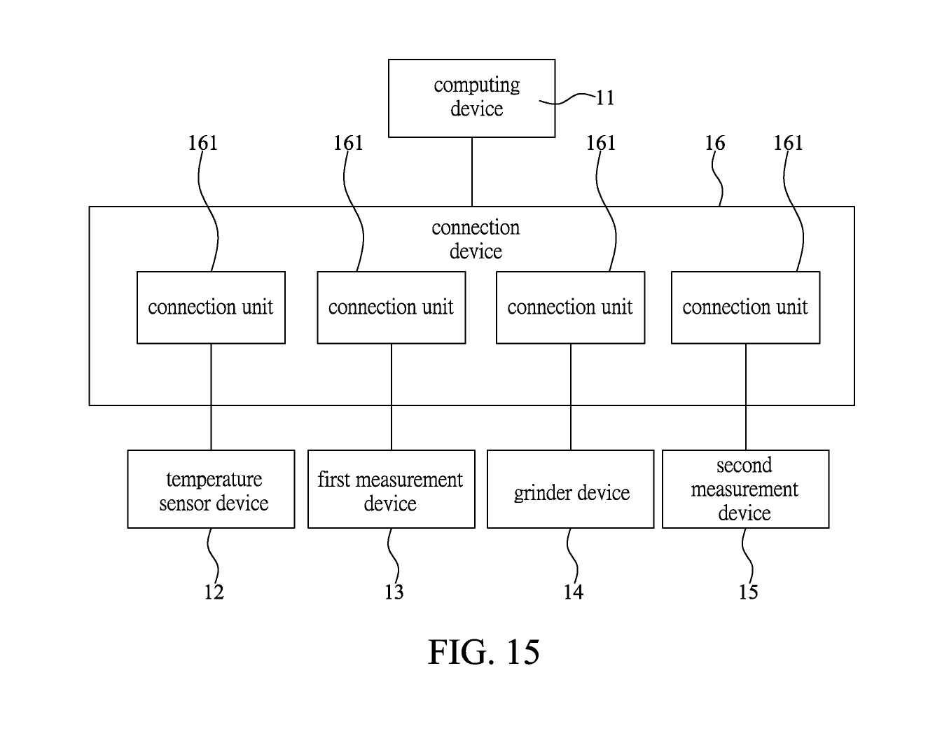

FIG. 15 is a modular block diagram of a connection device 16 included in a management system 10 according to a fourth preferred embodiment of the present invention. In the management system 10 of the fourth preferred embodiment, the connection device 16 is wirelessly connected to the computing device 11 and has four connection units 161, which are connected to one another.

As can be seen in FIG. 15, the four connection units 161 are wirelessly connected to the temperature sensor device 12 of the brewing device 20, the first measurement device 13, the grinder device 14, and the second measurement device 15 in a one-to-one correspondence, enabling the first weight information, the temperature information, the timing information and the flow information to be transferred via the connection units 161 of the connection device 16 to one of the temperature sensor device 12, the first measurement device 13, the grinder device 14 and the second measurement device 15, so that the device can display the first weight information, the temperature information, the timing information and the flow information. With these arrangements, the brewing operator can have an idea about the current brewing state from not only the display unit 114 of the computing device 11, but also any of one the temperature sensor device 12, the first measurement device 13, the grinder device 14 and the second measurement device 15. In the illustrated fourth preferred embodiment of the management system 10, the four connection units 161 are configured as chips with wireless connection modules; and the four chips together form a bus.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A beverage brewing management method, comprising:
a brewing step in which a solvent is poured into a solute, so that the solvent and the solute are mixed together to produce a beverage;
a comparing step in which a group of comparison-state information, which is created during the brewing step by measuring physical changes per unit time of the produced beverage, is compared with a group of standard-state information of the same unit time to determine whether the comparison-state information is approximate to the standard-state information; and
a reminding step in which a warning message is generated to remind a brewing operator when a difference between the comparison-state information and the standard-state information of the same unit time exceeds a preset error value.

2. The beverage brewing management method as claimed in claim 1, further comprising the following steps prior to the brewing step:
a standard brewing step in which the solvent is poured into the solute to produce a standard beverage;
a measuring step being performed synchronously with the standard brewing step to measure and record standard physical changes per unit time of the standard beverage to create a group of corresponding physical information; and
a standardizing step in which one of multiple groups of physical information, which are created by repeating the standard brewing step and the measuring step several times, is selected to be the standard-state information.

3. The beverage brewing management method as claimed in claim 2, further comprising a computing step between the measuring step and the standardizing step to perform a computation on the physical information to create a group of state information of the standard beverage.

4. The beverage brewing management method as claimed in claim 2, wherein the physical changes of the standard beverage include at least one of a weight increase per unit time of the standard beverage, temperature changes of the solvent and the beverage, and a total time elapsed in the standard brewing step.

5. The beverage brewing management method as claimed in claim 2, wherein, in the measuring step, a weight increase per unit time of the standard beverage is measured and a graphic data representing the physical information is created based on the measured weight increase.

6. The beverage brewing management method as claimed in claim 1, wherein the physical changes of the beverage include at least one of a weight increase per unit time of the beverage, a temperature change of the beverage and a total time elapsed in the brewing step.

7. A beverage brewing management system for managing a brewing process in which a solution is produced by mixing a solvent and a solute together and a beverage is extracted from the solution, comprising:
a computing device including a warning unit for displaying a warning message and a storage unit connected to the warning unit via a comparison unit and used to store a group of standard-state information per unit time;
a temperature sensor device being connected to the computing device to sense a temperature change per unit time of the solvent and create corresponding temperature information, which is transmitted to the comparison unit; and
a first measurement device being connected to the computing device and including a first weighing unit and a timer unit; the first weighing unit sensing a weight increase per unit time of the beverage to create corresponding first weight information, which is transmitted to the comparison unit; and the timer unit counting a total brewing process time to create corresponding timing information, which is also transmitted to the comparison unit; and
the comparison unit comparing the temperature information, the first weight information and the timing information with the standard-state information of the same unit time; and the comparison unit generating a warning signal to the warning unit for the latter to display a warning message when any one of the temperature information, the first weight information and the timing information created at a specific unit time does not match the standard-state information of the same unit time.

8. The beverage brewing management system as claimed in claim 7, further comprising a connection device connected to the computing device; the temperature sensor device and the first measurement device being connected to the computing device via the connection device; and the connection device being capable of transferring the temperature information, the first weight information and the timing information to one of the temperature sensor device and the first measurement device.

9. The beverage brewing management system as claimed in claim 8, wherein the connection device includes a plurality of connection units that are connected to one another; and the connection units being connected to the temperature sensor device and the first measurement device in a one-to-one correspondence.

10. The beverage brewing management system as claimed in claim 7, further comprising:
a grinder device being connected to the computing device and used to grind a solid material into the solute during a grinding process; and
a second measurement device being connected to the computing device and including a second weighing unit; the second weighing unit sensing a weight increase per unit time of the solute and creating corresponding second weight information, which is transmitted to the comparison device.

11. The beverage brewing management system as claimed in claim 10, wherein the grinder device includes a grinding unit to selectively start or stop grinding the solid material, and the comparison unit compares the second weight information with the standard-state information of the same unit time; and the comparison unit generating a stop signal to the grinding unit when the second weight information created at a specific unit time matching the standard-state information of the same unit time, causing the grinding unit to stop grinding the solid material.

12. The beverage brewing management system as claimed in claim 7, further comprising a brewing device, on which the temperature sensor device is provided; the brewing device including a control unit that provides control to selectively add or stop adding the solvent to the solute, and a liquid sensor device that is capable of sensing a weight increase per unit time of the solvent to create corresponding flow information and transmitting the flow information to the comparison unit.

13. The beverage brewing management system as claimed in claim 12, wherein the comparison unit compares the flow information with the standard-state information of the same unit time; the comparison unit generating a stop signal to the control unit when the flow information created at a specific unit time does not match the standard-state information of the same unit time, causing the control unit to stop the adding of the solvent to the solute.
